(19) United States
(12) Patent Application Publication
(10) Pub. No.: US 2026/0264499 A1
(43) Pub. Date: Sep. 10, 2026

(54) ELECTRIC DRIVE VEHICLE MODULAR CHASSIS INTEGRATED WITH DISTRIBUTED CORNER MODULE

(71) Applicant: TSINGHUA UNIVERSITY, BEIJING (CN)

(72) Inventors: Jin HUANG, BEIJING (CN); Yanzhao SU, BEIJING (CN); Xingyu LI, BEIJING (CN); Yu FENG, BEIJING (CN)

(21) Appl. No.: 19/560,815

(22) Filed: Mar. 9, 2026

(30) Foreign Application Priority Data
Mar. 10, 2025 (CN) 202510276137.8

(51) Int. Cl. B60K 1/04; B60G 7/00; B60K 7/00; B60K 17/04; B62D 5/04; H01M 10/613; H01M 10/625; H01M 10/6568; H01M 50/249

(52) U.S. Cl. CPC B60K 1/04; B60G 7/001; B60G 7/008; B60K 7/0007; B60K 17/043; B62D 5/0418; H01M 10/613; H01M 10/625; H01M 10/6568; H01M 50/249; B60K 2007/0038; H01M 2220/20

(57) ABSTRACT

The present application relates to an electric drive vehicle modular chassis integrated with distributed corner modules, including a vehicle frame, a suspension mechanism, a wheel, and a steering mechanism. The wheel is connected to the vehicle frame via the suspension mechanism. The steering mechanism includes a first steering assembly and a second steering assembly. The first steering assembly is disposed on the suspension mechanism, and the second steering assembly is disposed on the vehicle frame; the first steering assembly is configured to drive the wheel to rotate within a first angle range, and the second steering assembly is configured to drive the suspension mechanism to rotate within a second angle range, so that the suspension mechanism drives the wheel to rotate within the second angle range.

### CROSS-REFERENCE TO RELATED APPLICATIONS

The present application claims priority to Chinese Patent Application No. 2025102761378, filed on Mar. 10, 2025, entitled “Electric Drive Vehicle Modular Chassis Integrated with Distributed Corner Module”, the entire contents of which are incorporated herein by reference.

### TECHNICAL FIELD

The present application relates to the field of vehicle technology, and in particular to an electric drive vehicle modular chassis integrated with distributed corner modules.

### BACKGROUND

With the rapid development of electric drive vehicle technology, in the field of vehicle technology, four corner modules are integrated onto a vehicle frame to form a new type of electric drive vehicle modular chassis integrated with distributed corner modules.

A corner module includes a wheel driven by a hub motor, a braking mechanism, a suspension mechanism, and a steering mechanism. The wheel is powered by the hub motor to drive the vehicle to move. The suspension mechanism connects the vehicle frame and the wheel, supporting the wheel and buffering impacts from the road surface. The braking mechanism controls the wheel to stop or brake, thereby realizing the braking function of the vehicle. The steering mechanism can independently control the steering angle of each wheel, allowing the vehicle to steer and move flexibly. In the electric drive vehicle modular chassis integrated with distributed corner modules, each corner module is independently controlled to realize four-wheel independent drive and independent steering, enhancing the maneuverability and flexibility of the vehicle.

### SUMMARY

The present application provides an electric drive vehicle modular chassis integrated with distributed corner modules.

An electric drive vehicle modular chassis integrated with distributed corner modules, includes a vehicle frame, a suspension mechanism, a wheel, and a steering mechanism.

The wheel is connected to the vehicle frame via the suspension mechanism.

The steering mechanism includes a first steering assembly and a second steering assembly. The first steering assembly is disposed on the suspension mechanism, and the second steering assembly is disposed on the vehicle frame. The first steering assembly is configured to drive the wheel to rotate within a first angle range, and the second steering assembly is configured to drive the suspension mechanism to rotate within a second angle range, so that the suspension mechanism drives the wheel to rotate within the second angle range.

In an embodiment, the electric drive vehicle modular chassis integrated with distributed corner modules further includes a battery mechanism. The battery mechanism includes a battery pack and an elastic member. The vehicle frame is provided with an installation cavity for accommodating the battery pack, and the battery pack abuts against a cavity wall of the installation cavity via the elastic member.

In an embodiment, the electric drive vehicle modular chassis integrated with distributed corner modules further includes a cooling mechanism disposed on the vehicle frame and configured to cool the battery mechanism.

In an embodiment, the cooling mechanism includes a water tank, a liquid cooling pump, and an inlet of a heat exchanger connected sequentially through liquid cooling pipelines. The liquid cooling pipeline connected to the liquid cooling pump and the inlet of the heat exchanger passes through the battery pack. A water outlet of the heat exchanger is connected to the water tank, and an air outlet of the heat exchanger is communicated with the outside.

In an embodiment, the vehicle frame includes a first mounting frame, two second mounting frames, and two third mounting frames. The two second mounting frames are disposed on two sides of the first mounting frame along a length direction, respectively. Each third mounting frame is disposed on a side of a corresponding second mounting frame facing away from the first mounting frame, and a height of the second mounting frame is higher than heights of the first mounting frame and the third mounting frame. The first mounting frame, the second mounting frame, and the third mounting frame enclose to form a space for accommodating the wheel and the steering mechanism.

In an embodiment, the first steering assembly includes a first driving member, and a first transmission unit connected to an output end of the first driving member. The first driving member is fixed on the suspension mechanism, the first transmission unit is connected to the wheel, and the first driving member is capable of driving the first transmission unit to rotate, so that the first transmission unit drives the wheel to rotate within the first angle range.

The second steering assembly includes a second driving member, and a second transmission unit connected to an output end of the second driving member. The second driving member is fixed on the vehicle frame, the second transmission unit is connected to the suspension mechanism, and the second driving member is capable of driving the second transmission unit to rotate, so that the second transmission unit drives the suspension mechanism to rotate within the second angle range.

In an embodiment, the first transmission unit includes a first swing arm and a first connecting rod connected to each other. An end of the first swing arm away from the first connecting rod is connected to the first driving member, and an end of the first connecting rod away from the first swing arm is spherically hinged to the wheel.

In an embodiment, the second transmission unit includes a second swing arm and a second connecting rod connected to each other. An end of the second swing arm away from the second connecting rod is connected to the second driving member, and an end of the second connecting rod away from the second swing arm is spherically hinged to the suspension mechanism.

In an embodiment, the suspension mechanism includes a mounting assembly, a swing arm assembly, and a damping assembly.

The mounting assembly is connected to the vehicle frame.

One end of the swing arm assembly is connected to the mounting assembly, and another end of the swing arm assembly is connected to the wheel.

The damping assembly is connected to the mounting assembly and the swing arm assembly.

In an embodiment, the electric drive vehicle modular chassis integrated with distributed corner modules further includes a braking mechanism. The braking mechanism is configured to place the wheel in a braking state.

In the electric drive vehicle modular chassis integrated with distributed corner modules, the wheel is connected to the vehicle frame via the suspension mechanism. The suspension mechanism has a buffering and damping function. During travel, the electric drive vehicle modular chassis integrated with distributed corner modules will encounter various road conditions, such as potholes and bumps. The suspension mechanism can effectively absorb and buffer these impact forces from the road surface, minimizing the vertical vibration of the electric drive vehicle modular chassis integrated with distributed corner modules and avoiding excessive vertical bouncing of the electric drive vehicle modular chassis integrated with distributed corner modules. Furthermore, a steering mechanism is provided. By arranging the first steering assembly of the steering mechanism on the suspension mechanism, the wheel is driven by the first steering assembly to rotate within the first angle range to adapt to high-speed operating conditions of the electric drive vehicle modular chassis integrated with distributed corner modules. When parking or turning is required under low-speed operating conditions, while the first steering assembly drives the wheel to rotate within the first angle range, the second steering assembly drives the suspension mechanism to rotate within the second angle range, thereby driving the wheel to rotate within the second angle range. That is, the second steering assembly drives the suspension mechanism and the wheel to rotate together within the second angle range. At this time, the total rotation angle of the wheel is the sum of the first angle range and the second angle range. In the electric drive vehicle modular chassis integrated with distributed corner modules of the present application, the mutual cooperation of the first steering assembly and the second steering assembly increases the rotation angle of the wheel, thereby increasing the rotation angle of the electric drive vehicle modular chassis integrated with distributed corner modules and increasing the application scenarios of the electric drive vehicle modular chassis integrated with distributed corner modules.

### BRIEF DESCRIPTION OF THE DRAWINGS

FIG. 1 is a schematic view of an electric drive vehicle modular chassis integrated with distributed corner modules provided by an embodiment of the present application.

FIG. 2 is a schematic view of a vehicle frame provided by an embodiment of the present application.

FIG. 3A is a schematic view of a corner module provided by an embodiment of the present application.

FIG. 3B is a schematic view of the corner module shown in FIG. 3A from a second perspective.

FIG. 4 is a top view of the corner module shown in FIG. 3A.

FIG. 5 is a schematic view of the corner module shown in FIG. 3A from a third perspective.

FIG. 6 is a bottom view of the corner module shown in FIG. 3A.

FIG. 7 is a sectional view of the corner module shown in FIG. 3A.

FIG. 8 is a partial schematic view of the corner module shown in FIG. 3A.

### REFERENCE NUMERALS

100, suspension mechanism; 110, mounting assembly; 111, upper support seat; 1111, first connection component; 112, lower support seat; 1121, second connection component; 113, first support frame; 114, second support frame;
120, swing arm assembly; 121, upper swing arm; 122, lower swing arm; 1221, first lower arm section; 1222, second lower arm section;
130, transmission assembly; 131, transmission arm; 1311, first transmission end; 1312, fulcrum end; 1313, second transmission end; 132, first push rod; 133, second push rod;
140, damping assembly;
210, first driving member; 220, first transmission unit; 221, first swing arm; 222, first connecting rod;
310, second driving member; 320, second transmission unit; 321, second swing arm; 322, second connecting rod;
400, wheel;
500, braking mechanism; 510, brake disc; 520, brake caliper; 530, braking motor;
600, vehicle frame; 610, first mounting frame; 620, second mounting frame; 630, third mounting frame;
700, battery mechanism;
800, cooling mechanism.

### DETAILED DESCRIPTION OF THE EMBODIMENTS

To make the objectives, features, and advantages of the present application more apparent and understandable, the specific embodiments of the present application will be described in detail below with reference to the accompanying drawings. Numerous specific details are set forth in the following description to facilitate a full understanding of the present application. However, the present application can be implemented in many other ways different from those described herein, and those skilled in the art can make similar improvements without departing from the connotation of the present application. Therefore, the present application is not limited to the specific embodiments disclosed below.

In the description of the present application, it should be understood that if terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc., appear, the orientation or positional relationship indicated by these terms is based on the orientation or positional relationship shown in the drawings, and is merely for the convenience of describing the present application and simplifying the description, rather than indicating or implying that the referred device or element must have a specific orientation or be constructed and operated in a specific orientation, and therefore cannot be understood as a limitation on the present application.

In addition, if the terms “first” and “second” appear, these terms are used for descriptive purposes only and cannot be understood as indicating or implying relative importance or implicitly indicating the quantity of the indicated technical features. Thus, a feature defined as “first” or “second” may explicitly or implicitly include at least one such feature. In the description of the present application, if the term “plurality” appears, the meaning of “plurality” is at least two, for example, two, three, etc., unless clearly and specifically defined otherwise.

In the present application, unless explicitly specified and limited otherwise, if terms such as “installed”, “connected”, “attached”, “fixed” etc., appear, these terms should be understood in a broad sense. For example, it may be a fixed connection or a detachable connection, or an integral formation; it may be a mechanical connection or an electrical connection; it may be a direct connection, or an indirect connection through an intermediate medium, or it may be an internal communication between two elements or an interaction relationship between two elements, unless explicitly limited otherwise. For those of ordinary skill in the art, the specific meanings of the above terms in the present application can be understood according to specific situations.

In the present application, unless explicitly specified and limited otherwise, if there is a description of a first feature being “on” or “under” a second feature, or similar descriptions, which may mean that the first and second features are in direct contact, or that the first and second features are in indirect contact through an intermediate medium. Moreover, the first feature being “above”, “over” and “on top of” the second feature may mean that the first feature is directly above or obliquely above the second feature, or simply indicates that the horizontal height of the first feature is higher than that of the second feature. The first feature being “below”, “under”, and “underneath” the second feature may mean that the first feature is directly below or obliquely below the second feature, or simply indicates that the horizontal height of the first feature is less than that of the second feature.

It should be noted that if an element is referred to as being “fixed to” or “disposed on” another element, the element may be directly on the other element, or an intervening element may also be present. If an element is considered to be “connected to” to another element, it may be directly connected to the other element, or an intervening element may likely also be present. If presented, the terms “vertical”, “horizontal”, “upper”, “lower”, “left”, “right”, and similar expressions used in the present application are for illustrative purposes only and do not represent the only implementation.

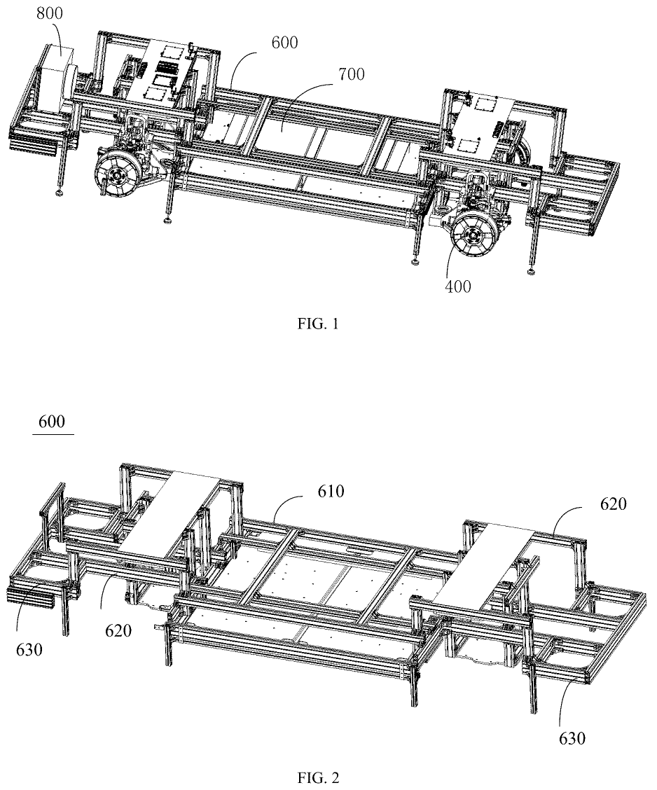

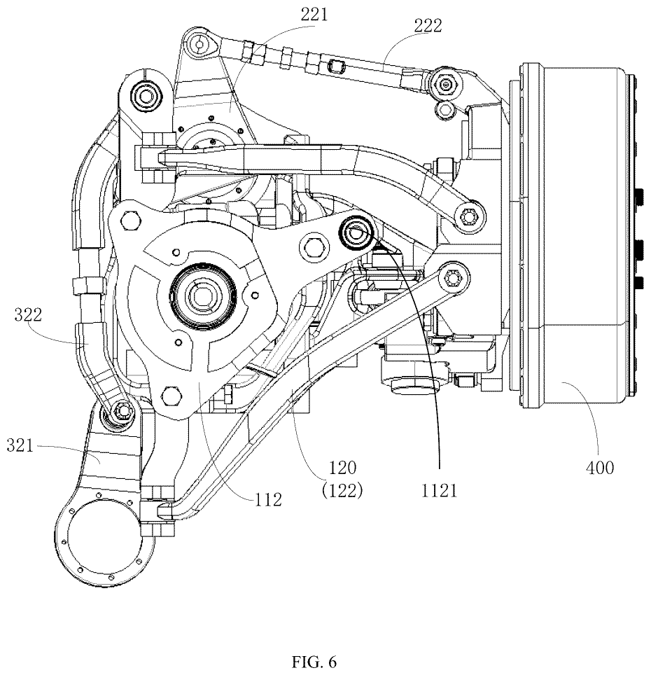

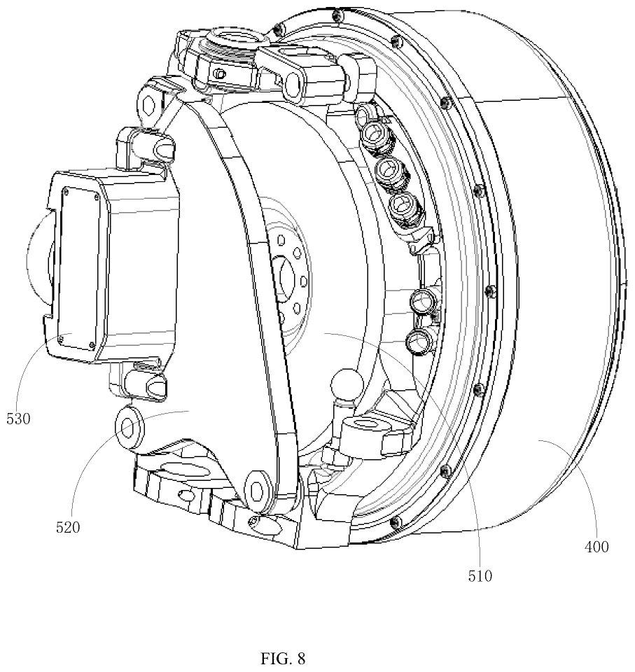

A wheel turning angle of the existing electric drive vehicle modular chassis integrated with distributed corner modules is limited, which restricts the application scenarios of the electric drive vehicle modular chassis integrated with distributed corner modules. An embodiment of the present application provides an electric drive vehicle modular chassis integrated with distributed corner modules. Referring to FIG. 1 to FIG. 8, the electric drive vehicle modular chassis integrated with distributed corner modules includes a vehicle frame 600, a suspension mechanism 100, a wheel 400, and a steering mechanism. The vehicle frame 600 is connected to the wheel 400 via the suspension mechanism 100. The steering mechanism includes a first steering assembly and a second steering assembly. The first steering assembly is disposed on the suspension mechanism 100, and the second steering assembly is disposed on the vehicle frame 600. The first steering assembly is configured to drive the wheel 400 to rotate within a first angle range, and the second steering assembly is configured to drive the suspension mechanism 100 to rotate within a second angle range, so that the suspension mechanism 100 drives the wheel 400 to rotate within the second angle range.

In the electric drive vehicle modular chassis integrated with distributed corner modules, the wheel 400 is connected to the vehicle frame 600 via the suspension mechanism 100. The suspension mechanism 100 has a buffering and damping function. During travel, the electric drive vehicle modular chassis integrated with distributed corner modules will encounter various road conditions, such as potholes and bumps. The suspension mechanism 100 can effectively absorb and buffer these impact forces from the road surface, minimizing the vertical vibration of the electric drive vehicle modular chassis integrated with distributed corner modules and avoiding excessive vertical bouncing of the electric drive vehicle modular chassis integrated with distributed corner modules. Furthermore, a steering mechanism is provided. By arranging the first steering assembly of the steering mechanism on the suspension mechanism 100, the wheel 400 is driven by the first steering assembly to rotate within the first angle range to adapt to high-speed operating conditions of the electric drive vehicle modular chassis integrated with distributed corner modules. When parking or turning is required under low-speed operating conditions, while the first steering assembly drives the wheel 400 to rotate within the first angle range, the second steering assembly drives the suspension mechanism 100 to rotate within the second angle range, thereby driving the wheel 400 to rotate within the second angle range. That is, the second steering assembly drives the suspension mechanism 100 and the wheel 400 to rotate together within the second angle range. At this time, the total rotation angle of the wheel 400 is the sum of the first angle range and the second angle range. In the electric drive vehicle modular chassis integrated with distributed corner modules of the present application, the mutual cooperation of the first steering assembly and the second steering assembly increases the rotation angle of the wheel 400, thereby increasing the rotation angle of the electric drive vehicle modular chassis integrated with distributed corner modules and increasing the application scenarios of the electric drive vehicle modular chassis integrated with distributed corner modules.

In this embodiment, as shown in FIG. 1, the vehicle frame 600 is provided with four sets of corner modules, and one set of corner module includes one wheel 400, one braking mechanism 500, one suspension mechanism 100, and one steering mechanism. That is, in one electric drive vehicle modular chassis integrated with distributed corner modules, four wheels 400, four braking mechanisms 500, four suspension mechanisms 100, and four steering mechanisms are disposed on the vehicle frame 600. One wheel 400, one braking mechanism 500, one suspension mechanism 100, and one steering mechanism are integrated into a set of corner modules. The four sets of corner modules are disposed at the front left, front right, rear left, and rear right positions of the vehicle frame 600 respectively, capable of realizing independent driving and independent steering of each wheel. For example, functions such as entire vehicle front-axle steering, rear-axle steering, four-wheel same-direction steering, four-wheel opposite-direction steering, wedge-shaped steering, transverse movement and pivot steering can be realized, which provides more possibilities for vehicle driving flexibility, allowing for flexible steering functions such as small-radius steering and wedge-shaped lane changes, while also enabling flexible switching between various steering functions such as front-wheel steering, rear-wheel steering, four-wheel same-direction steering, and four-wheel opposite-direction steering.

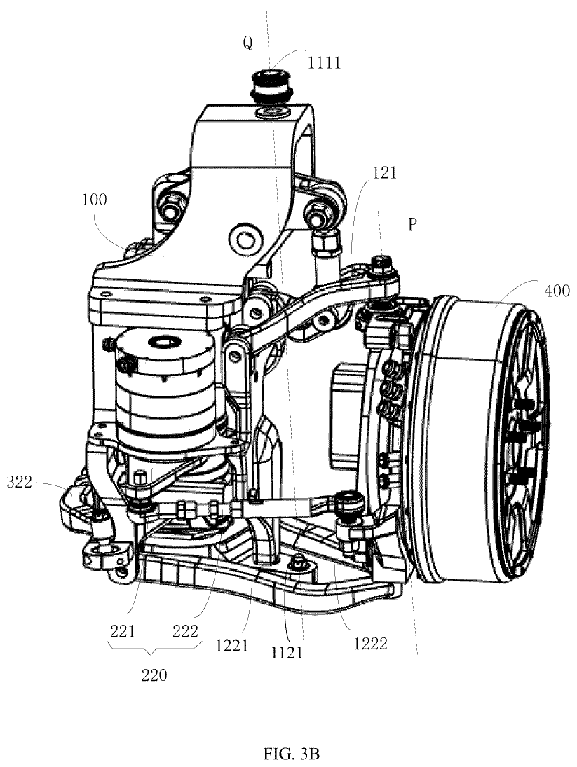

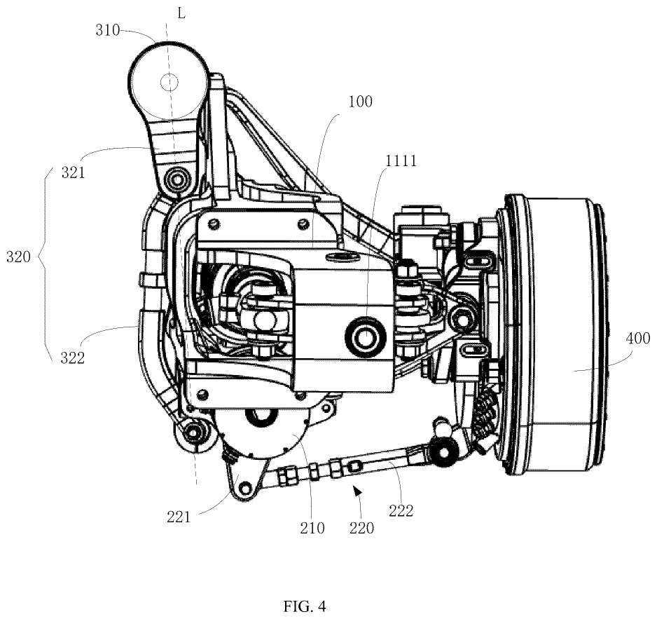

Further, in order to increase the rotation angle of the corner module, i.e., to increase the rotation angle of the wheel 400, as shown in FIG. 3A to FIG. 8, the steering mechanism includes a first steering assembly and a second steering assembly. As shown in FIGS. 3A-3B, the first steering assembly includes a first driving member 210 and a first transmission unit 220 connected to an output end of the first driving member 210. The first driving member 210 is fixed on the suspension mechanism 100, and the first transmission unit 220 is connected to the wheel 400. The first driving member 210 is capable of driving the first transmission unit 220 to rotate, so that the first transmission unit 220 drives the wheel 400 to rotate within the first angle range. As shown in FIGS. 3A-3B and FIG. 4, the second steering assembly includes a second driving member 310 and a second transmission unit 320 connected to the second driving member 310. The second driving member 310 is fixed on the vehicle frame 600, and the second transmission unit 320 is connected to the suspension mechanism 100. The second driving member 310 is capable of driving the second transmission unit 320 to rotate, so that the second transmission unit 320 drives the suspension mechanism 100 to rotate within the second angle range.

In this embodiment, when the vehicle is traveling at medium to high speeds or has conventional steering requirements, only the first steering assembly may be operated. The first driving member 210 drives the first transmission unit 220 to rotate, and the first transmission unit 220 drives the wheel 400 to rotate within the first angle range to adapt to the high-speed operating conditions of the vehicle. In this case, since the rotation range of the wheel 400 is relatively small, it is convenient to ensure steering stability of the vehicle during high-speed driving.

When parking or turning is required under low-speed operating conditions, the first steering assembly and the second steering assembly can be operated simultaneously. The first driving member 210 drives the wheel 400 to rotate within the first angle range through the first transmission unit 220, and the second driving member 310 drives the suspension mechanism 100 and the wheel 400 to rotate within the second angle range through the second transmission unit 320. That is, the total rotation angle range of the wheel 400 is the sum of the first angle range and the second angle range, which greatly increases the rotation angle range of the wheel 400. That is, the present application guarantees both the steering stability of the wheel at high speeds and realizes a large-angle rotation of the wheel at low speeds.

In addition, the first transmission unit 220 and the second transmission unit 320 are arranged independently, so that the first steering assembly and the second steering assembly are mechanically decoupled. When one fails, the other can drive the wheel 400 to rotate normally, thereby increasing the redundancy backup of the steer-by-wire system and improving steering reliability.

In an embodiment, the first angle range is −45° to +45°, and the second angle range is −45° to +45°. In this embodiment, both the first angle range and the second angle range are −45° to +45°, that is, when the first steering assembly and the second steering assembly simultaneously drive the wheel 400 to rotate, the total steering angle range of the wheel 400 is −90° to +90°. During parking, the vehicle can move transversely to achieve rapid parking.

In another embodiment, the first angle range is 0 to 30°, and the second angle range is 0 to 60°. When the first steering assembly and the second steering assembly simultaneously drive the wheel 400 to rotate, the total steering angle range of the wheel 400 is also 0 to 90°. That is, the first angle range and the second angle range can be combined in different ways.

Of course, under some special operating conditions, the first steering assembly or the second steering assembly can also be adjusted so that the total rotation angle is greater than 90°.

In some embodiments of the present application, as shown in FIG. 3A to FIG. 8, the suspension mechanism 100 and the first transmission unit 220 are respectively spherically hinged to the wheel 400. The suspension mechanism 100 has a virtual kingpin axis P (shown in FIG. 3B) rotatably connected to the wheel 400, and the first transmission unit 220 is configured to drive the wheel 400 to rotate around the virtual kingpin axis P.

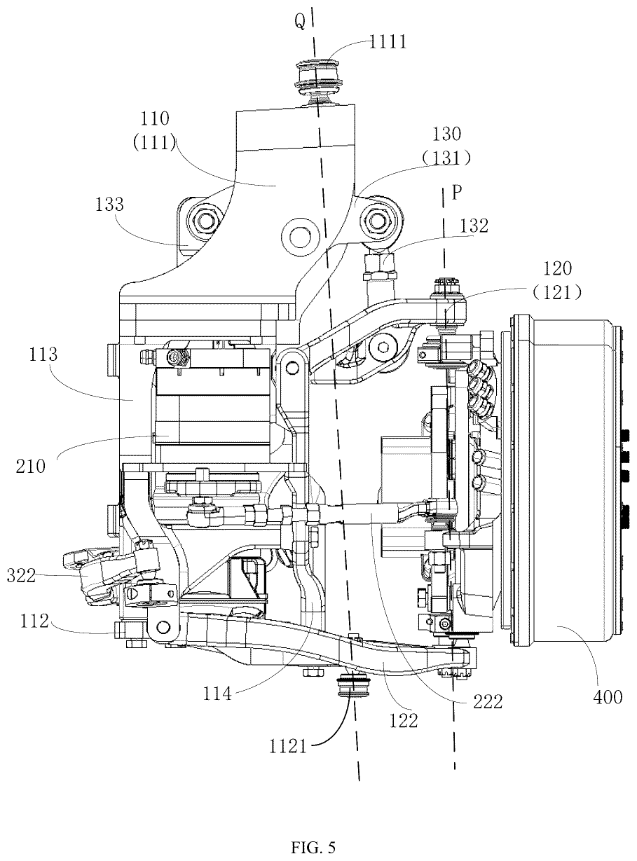

As shown in FIGS. 3A to 3B and FIG. 5, the suspension mechanism 100 has an upper swing arm 121 and a lower swing arm 122. The lower swing arm 122 includes a first lower arm section 1221 and a second lower arm section 1222. The upper swing arm 121 is spherically hinged to the upper part of the wheel 400, and the first lower arm section 1221 and the second lower arm section 1222 are respectively spherically hinged to the bottom of the wheel 400. Extensions of the first lower arm section 1221 and the second lower arm section 1222 can form an intersection point. The virtual kingpin axis P passes through the intersection point and the spherical hinge point where the upper swing arm 121 is connected to the upper part of the wheel 400.

The determination method of the virtual kingpin axis P, which is an important parameter in the suspension mechanism 100, is known in the prior art and will not be described in detail here.

In this embodiment, as shown in FIG. 3A to FIG. 5, the wheel 400 is spherically hinged to the suspension mechanism 100, and the suspension mechanism 100 can ensure that there is stable mechanical support between the tire contact patch and the suspension mechanism 100 system. On this basis, the first transmission unit 220 is spherically hinged to the wheel 400, so that the first transmission unit 220 drives the wheel 400 to rotate around the virtual kingpin axis P, which can ensure stable steering of the wheel 400.

Taking a four-wheel vehicle as an example, a four-wheel vehicle has two front wheels and two rear wheels. The sides where the two front wheels or rear wheels are close to each other are the inner sides, and the suspension mechanism 100 is disposed on the inner side of the wheel 400.

In other embodiments, the steering mechanism of the present application can also be applied to two-wheeled, three-wheeled, five-wheeled, and other multi-wheeled vehicles.

A spherical hinge, also called a ball joint, is a connection method capable of achieving rotation in multiple directions and a certain degree of displacement. A spherical hinge includes a ball head, a ball socket, a connection component, and sealing and lubrication components. The ball head is generally a spherical metal component capable of rotating freely within a certain space. The ball socket is a component engaging with the ball head, and having a concave spherical shape. The ball head is embedded in the ball socket, and the ball socket provides support and constraint for the ball head and allows the ball head to rotate within a specified range. The connection component is configured to connect the ball head and the ball socket to other structural components.

In some embodiments of the present application, as shown in FIG. 3A to FIG. 8, the first transmission unit 220 includes a first swing arm 221 and a first connecting rod 222 connected to each other. One end of the first swing arm 221 away from the first connecting rod 222 is connected to the first driving member 210, and one end of the first connecting rod 222 away from the first swing arm 221 is spherically hinged to the wheel 400.

In an embodiment, as shown in FIG. 3A to FIG. 8, the first driving member 210 is a motor. The motor is disposed on the suspension mechanism 100. The motor is configured to drive the first swing arm 221 to swing in a horizontal plane, so as to drive the first connecting rod 222 to swing through the first swing arm 221, thereby causing the wheel 400 to rotate around the virtual kingpin axis P. The first transmission unit 220 adopts the rotation form of the first swing arm 221 and the first connecting rod 222, which can optimize steering force and comprehensively improve high-speed steering stability.

Further, the length of the first connecting rod 222 is adjustable. In an embodiment, the initial phase angle of the first driving member 210 is changed by adjusting the length of the first connecting rod 222, thereby changing the first angular range. For example, the first angle range is changed from ±45° to −40 ° to 50°, so as to adapt to the installation requirements of different vehicles.

In an embodiment of the present application, as shown in FIG. 3A to FIG. 8, the suspension mechanism 100 has a first connection component 1111 and a second connection component 1121. The first connection component 1111 and the second connection component 1121 are respectively configured for being spherically hinged to the vehicle frame 600. The line connecting the first connection component 1111 and the second connection component 1121 constructs a virtual secondary pin axis Q (shown in FIG. 3B), and the second transmission unit 320 is configured to drive the suspension mechanism 100 to rotate around the virtual secondary pin axis Q.

Wherein, the virtual kingpin axis P needs to satisfy the condition that when the wheel 400 is at a 90° turning angle, the wheel 400 is exactly perpendicular to the bottom surface. After the position of the virtual kingpin axis P is determined, first, based on the installable ranges of the first connection component 1111 and the second connection component 1121 (the installable range is constrained by the spatial limitations of the vehicle frame 600), the axis matrix calculation method is used to determine the solution set of axes that meet the requirements. Then, Adams software is employed to verify whether the actually modeled axis satisfies the set conditions, thereby determining the specific positions of the first connection component 1111 and the second connection component 1121, that is, the position of the virtual kingpin axis P.

In an embodiment, as shown in FIG. 3A to FIG. 8, the second driving member 310 is fixed on the vehicle frame 600. The second driving member 310 is configured to drive the suspension mechanism 100 and the wheel 400 to simultaneously rotate around the virtual secondary pin axis Q through the second transmission unit 320, so as to further increase the rotation angle of the wheel 400 on the basis of the first transmission unit 220 driving the wheel 400 to rotate.

In an embodiment, as shown in FIG. 3A to FIG. 8, the first connection component 1111 is located at one end of the suspension mechanism 100 along the vertical direction, and the second connection component 1121 is located at the other end of the suspension mechanism 100 along the vertical direction. Along the vertical direction, the first transmission unit 220 is located between the first connection component 1111 and the second connection component 1121 (shown in FIG. 3B).

In an embodiment, as shown in FIG. 3A to FIG. 8, the upper part of the suspension mechanism 100 is spherically hinged to the vehicle frame 600 via the first connection component 1111, and the bottom of the suspension mechanism 100 is spherically hinged to the vehicle frame 600 via the second connection component 1121, improving the stability of the connection between the suspension mechanism 100 and the vehicle frame 600. On this basis, the first transmission unit 220 is positioned between the first connection component 1111 and the second connection component 1121 along the vertical direction, which can effectively improve the driving stability of the second steering assembly.

In summary, the suspension mechanism 100 is connected to the vehicle frame 600. That is, the connection between the corner module and the vehicle frame 600 adopts spherical hinging, which can achieve rotation and swinging of the corner module within a certain range to adapt to different dynamic operating conditions. Spherical hinging provides a high degree of freedom, allowing natural adjustment of the corner module when the vehicle body moves laterally, longitudinally, or vertically, thereby reducing the adverse effects of relative movement between the corner module and the vehicle body on vehicle handling performance.

Connection points (the first connection component 1111 and the second connection component 1121) are provided at the upper and lower ends of the corner module, respectively. Through such a design, the corner module can achieve stable connection and movement under the constraint of the rotating pair. These connection points (marked as support points) are connected to the vehicle body through the ball joints of the spherical hinges, ensuring that the connection between the vehicle body and the corner module is not only strong but also flexible enough to adapt to vehicle movement. Moreover, these two connection points are connected to the vehicle frame 600 through ball joints, which can absorb forces and movements generated during steering, or deformation of the suspension mechanism 100 or the vehicle frame 600. The rotating pair of each corner module is effectively connected to other parts of the vehicle frame 600 through these connection points, ensuring the linkage between the vehicle frame 600 and each corner module.

In an embodiment of the present application, as shown in FIG. 4, in some embodiments, the second transmission unit 320 is disposed on a side of the suspension mechanism 100 away from the wheel 400. That is, the second transmission unit 320 is installed in the space between two wheels 400, thereby effectively utilizing the space between the two wheels 400 and making the structure compact.

Specifically, as shown in FIG. 3A to FIG. 6, the second transmission unit 320 includes a second swing arm 321 and a second connecting rod 322 connected sequentially. One end of the second swing arm 321 away from the second connecting rod 322 is connected to the second driving member 310, and one end of the second connecting rod 322 away from the second swing arm 321 is spherically hinged to the suspension mechanism 100.

In an embodiment, as shown in FIG. 3A to FIG. 8, the second driving member 310 is a motor. The motor is fixed on the vehicle frame 600. When the motor rotates, it can drive the second swing arm 321 to swing in a horizontal plane, thereby driving the second connecting rod 322 to swing relative to the suspension mechanism 100, so that the suspension mechanism 100 can rotate around the virtual secondary pin axis Q.

In other embodiments, the second driving member 310 is a cylinder, and the second transmission unit 320 is a telescopic rod. The extension and contraction of the telescopic rod can directly drive the suspension mechanism 100 to rotate around the virtual secondary pin axis Q.

Further, as shown in FIG. 3A to FIG. 8, the second transmission unit 320 has a locked state. When the second transmission unit 320 is in the locked state, the rotation center of the second driving member 310, the connection point of the second swing arm 321 and the second connecting rod 322, and the connection point of the second connecting rod 322 and the suspension mechanism 100 are located on the same straight line L (as shown in FIG. 4).

In this embodiment, when the vehicle is in a high-speed driving state, the second transmission unit 320 can be locked as the second steering assembly is not required at this time. Specifically, when the second transmission unit 320 is in the locked state, the rotation center of the second driving member 310, the connection point of the second swing arm 321 and the second connecting rod 322, and the connection point of the second connecting rod 322 and the suspension mechanism 100 are located on the same straight line. At this time, the road surface force transmitted by the first connecting rod 222 will not generate additional torque on the second driving member 310. Moreover, the self-locking of the second transmission unit 320 does not affect the execution of the first transmission unit 220, so as to achieve the purpose of mutual decoupling between the first steering assembly and the second steering assembly, thereby further increasing stability during high-speed driving and conventional steering.

In an embodiment of the present application, the length of the second connecting rod 322 is adjustable. The initial phase angle of the second driving member 310, i.e., the second angle range, is changed by adjusting the length of the second connecting rod 322. For example, the second angle range is changed from −45° to 45° to −40 ° to 50°, so as to adapt to the installation requirements of different vehicles.

In an embodiment of the present application, as shown in FIG. 3A to FIG. 8, the suspension mechanism 100 is rotatably disposed on the vehicle frame 600, and the wheel 400 is rotatably disposed on the suspension mechanism 100. Moreover, the first driving member 210 is fixed on the suspension mechanism 100, and the first transmission unit 220 is configured to connect to the wheel 400. The first driving member 210 is configured to drive the wheel 400 to rotate within the first angle range through the first transmission unit 220. The second driving member 310 is configured to be fixed on the vehicle frame 600, the second transmission unit 320 is connected to the suspension mechanism 100, and the second driving member 310 is configured to drive the suspension mechanism 100 and the wheel 400 to rotate within the second angle range through the second transmission unit 320 (as shown in FIG. 4).

As shown in FIG. 3A to FIG. 8, in some embodiments, the steering mechanism has a first operating state and a second operating state.

When the steering mechanism is in the first operating state, the driving method includes the following steps: the first driving member 210 rotates, driving the first transmission unit 220 to move so as to drive the wheel 400 to rotate within the first angle range. The first operating state may be when the vehicle is traveling at medium to high speeds or has conventional steering requirements.

When the steering mechanism is in the second operating state, the driving method includes the following steps: the first driving member 210 rotates, driving the first transmission unit 220 to move so as to drive the wheel 400 to rotate within the first angle range; the second driving member 310 rotates, driving the second transmission unit 320 to move so as to drive the suspension mechanism 100 and the wheel 400 to simultaneously rotate within the second angle range. The second operating state may be when the vehicle is parking or turning under low-speed operating conditions.

In this embodiment, when parking or turning is required under low-speed operating conditions, the first steering assembly and the second steering assembly are controlled simultaneously. At this time, the first driving member 210 drives the wheel 400 to rotate within the first angle range through the first transmission unit 220, and simultaneously the second driving member 310 drives the suspension mechanism 100 and the wheel 400 to rotate within the second angle range through the second transmission unit 320. That is, the total rotation angle of the wheel 400 is the sum of the first angle range and the second angle range, which greatly increases the rotation angle of the wheel 400 while also ensuring the stability of the wheel 400.

Further, referring to FIG. 3A to FIG. 8, the suspension mechanism 100 includes a mounting assembly 110, a swing arm assembly 120, and a damping assembly 140 (as shown in FIG. 3). The mounting assembly 110 is configured to be connected to the vehicle frame 600. One end of the swing arm assembly 120 is connected to the mounting assembly 110, and the other end of the swing arm assembly 120 is connected to the wheel 400 (as shown in FIG. 3A, and FIG. 5). The damping assembly 140 is connected to the mounting assembly 110 and connected to the swing arm assembly 120 (as shown in FIG. 3A). The mounting assembly 110 is directly connected to the vehicle frame 600, thereby transmitting the weight of the vehicle frame 600 to the swing arm assembly 120, and finally dispersing the weight to the ground through the wheel 400. The swing arm assembly 120 connects the wheel 400 and the vehicle frame 600, allowing the wheel 400 to move in the vertical direction while maintaining the relative position with the vehicle frame 600, thereby ensuring that the wheel 400 always maintains good contact with the ground. In addition, the swing arm assembly 120 is capable of transmitting certain lateral and longitudinal forces, for example, transmitting reaction forces from the ground (such as bumps, lateral forces, etc.) to the damping assembly 140, which then buffers and absorbs these reaction forces through the damping assembly 140. Accurately controlling the movement trajectory of the wheel 400 through the swing arm assembly 120 helps to improve the stability and handling performance of the vehicle.

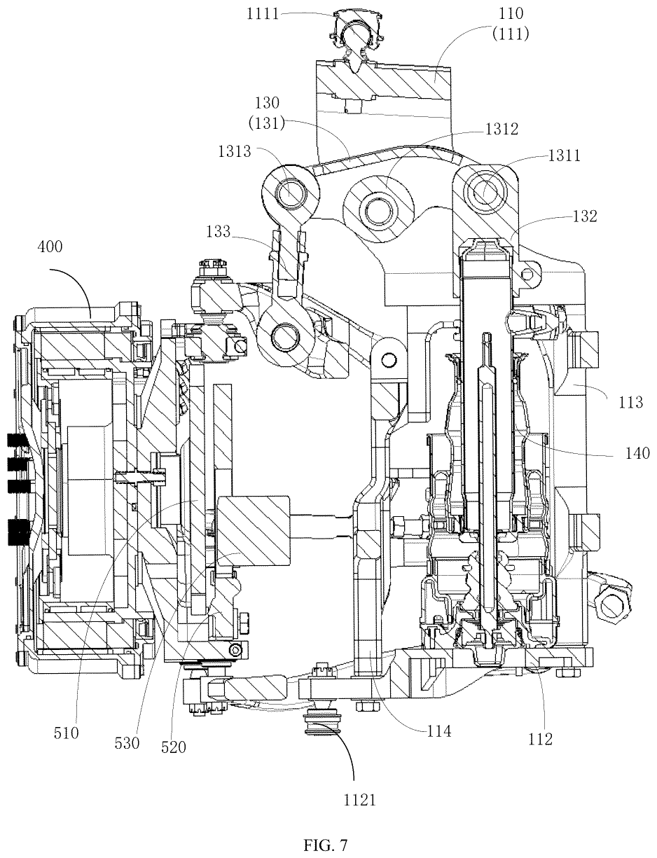

In an embodiment of the present application, referring to FIG. 3A to FIG. 8, the mounting assembly 110 includes an upper support seat 111, a lower support seat 112, a first support frame 113, and a second support frame 114. The upper support seat 111 and the lower support seat 112 are arranged at an interval along the vertical direction, and both are configured for connecting to the vehicle frame 600. The first support frame 113 is connected between the upper support seat 111 and the lower support seat 112. The second support frame 114 is connected to the first support frame 113 along the vertical direction, and connected to the lower support seat 112 (as shown in FIGS. 5 and 7).

In an embodiment, a ball hinge point is provided at the top of the upper support seat 111, and a ball hinge point is provided at the bottom of the lower support seat 112. The upper support seat 111 and the lower support seat 112 are connected to the vehicle frame 600 through their respective ball hinge points, respectively. Using the ball hinge points as the rotating joints of the suspension mechanism 100 allows the wheel to move freely in multiple directions, thus ensuring steering flexibility and the normal operation of the suspension mechanism 100.

In an embodiment of the present application, referring to FIG. 3A to FIG. 8, the swing arm assembly 120 includes an upper swing arm 121 and a lower swing arm 122. One end of the upper swing arm 121 along the horizontal direction is rotatably connected to the wheel 400, and the other end of the upper swing arm 121 along the horizontal direction is rotatably connected to the second support frame 114. One end of the lower swing arm 122 along the horizontal direction is connected to the wheel 400, and the other end of the lower swing arm 122 along the horizontal direction is rotatably connected to the first support frame 113 (as shown in FIG. 5). The upper swing arm 121 and the lower swing arm 122 allow for more precise adjustment of the wheel angles, such as camber angle or toe-in angle, so that the wheel maintains the maximum contact area with the ground under various road conditions, thereby providing better grip and traction to maintain the straight-line driving stability of the vehicle.

Moreover, higher lateral rigidity can be provided, thus reducing the twisting deformation of the vehicle body during steering, and enhancing the overall rigidity of the vehicle. Moreover, the force distribution is more uniform. The synergistic effect between the upper swing arm 121 and the lower swing arm 122 reduces the stress on individual components and extends the service life of the suspension mechanism 100. In some embodiments, the upper swing arm 121 and the lower swing arm 122 are approximately A-shaped, which can provide better handling and comfort.

In an embodiment of the present application, referring to FIG. 3A to FIG. 8, the suspension mechanism 100 further includes a transmission assembly 130. One end of the transmission assembly 130 along the horizontal direction is rotatably connected to the upper swing arm 121, and the other end of the transmission assembly 130 along the horizontal direction is rotatably connected to the damping assembly 140. The force transmitted to the swing arm assembly 120 is transmitted to the damping assembly 140 via the transmission assembly 130, and is buffered and absorbed by the damping assembly 140, which helps to improve the stability and handling performance of the vehicle.

In an embodiment of the present application, referring to FIG. 3A to FIG. 8, the transmission assembly 130 includes a transmission arm 131, a first push rod 132, and a second push rod 133. The transmission arm 131 includes a fulcrum end 1312, a first transmission end 1311, and a second transmission end 1313 distributed along the horizontal direction. The fulcrum end 1312 is rotatably connected to the upper support seat 111 (as shown in FIG. 7). One end of the first push rod 132 is rotatably connected to the first transmission end 1311 (as shown in FIG. 7), and the other end is rotatably connected to the upper swing arm 121 (as shown in FIG. 5). One end of the second push rod 133 is rotatably connected to the second transmission end 1313, and the other end is rotatably connected to the damping assembly 140 (as shown in FIG. 7). When the road surface is uneven causing the wheel to bump up and down, the upper swing arm 121 will move up and down with the wheel.

Since the transmission arm 131 is connected between the upper swing arm 121 and the damping assembly 140, along with the movement of the upper swing arm 121, the transmission arm 131 will also correspondingly push or pull the damping assembly 140, thus buffering and absorbing through the damping assembly 140, which helps to improve the stability and handling performance of the vehicle. Compared with the prior art that the shock absorber is directly installed near the wheel, the upper swing arm 121 and the damping assembly 140 of the present application are connected through the transmission assembly 130, so that the damping assembly 140 can be installed inside the vehicle frame 600, which can reduce the occupation of the vehicle space, thereby optimizing the overall spatial layout. Moreover, by changing the installation position of the damping assembly 140, the center of gravity of the vehicle can be better distributed, which helps to improve handling and stability.

In an embodiment of the present application, referring to FIG. 3A to FIG. 8, the first transmission end 1311 and the second transmission end 1313 are located on two sides of the fulcrum end 1312, respectively, and the distance between the first transmission end 1311 and the fulcrum end 1312 is different from the distance between the second transmission end 1313 and the fulcrum end 1312. That is to say, the transmission arm 131 is designed as a lever structure, the first transmission end 1311 is equivalent to the power end, and the second transmission end 1313 is equivalent to the resistance end. By adjusting the first distance between the first transmission end 1311 and the fulcrum end 1312, and the second distance between the second transmission end 1313 and the fulcrum end 1312, the influence of the wheel's movement along the vertical direction on the shock absorber can be amplified or reduced. For example, when the second distance is smaller, a larger compression amount of the shock absorber can be produced within a smaller wheel stroke, thereby providing a more sensitive response. When the second distance is larger, the movement amplitude of the shock absorber is relatively small, which is suitable for scenarios pursuing smoothness and comfort. By adjusting the proportional relationship between the first distance and the second distance, different driving conditions and needs can be adapted.

In an embodiment of the present application, referring to FIG. 3A to FIG. 8, the impact load from the road is transmitted to the wheel 400, the swing arm assembly 120, the transmission assembly 130, and the damping assembly 140 sequentially. The damping assembly 140 absorbs and slows down the impact load from the road, enabling the vehicle to have good handling stability and improving the ride comfort of the user.

In some embodiments, the damping assembly 140 includes a shock absorber, which may be a mono-tube shock absorber or a twin-tube shock absorber. When the vehicle encounters bumps, the wheel moves upward, and under the action of the transmission arm 131, pushes the piston rod of the shock absorber to move downward. The piston moves in the hydraulic oil, forcing the oil to pass through small holes or valves in the piston to generate damping force. This process converts mechanical energy into heat energy, thereby effectively reducing the vibration of the vehicle body. Similarly, when the wheel falls, the piston moves upward, thus generating damping force to reduce the vibration of the vehicle body.

Referring to FIG. 3A to FIG. 8, in some embodiments, the damping assembly 140 may further include a coil spring. Taking the shock absorber as a twin-tube shock absorber as an example, a spring seat can be arranged on the twin-tube shock absorber, and the coil spring is installed within the spring seat. When the vehicle encounters bumps causing the wheel to move upward, the coil spring is compressed to store impact energy, and the shock absorber consumes the stored energy in the form of heat through hydraulic damping, thereby effectively attenuating the vibration impact transmitted from the road surface to the vehicle body.

Further, referring to FIG. 3A to FIG. 8, the electric drive vehicle modular chassis integrated with distributed corner modules provided by an embodiment of the present application further includes a braking mechanism 500. The braking mechanism 500 is located between the wheel 400 and the suspension mechanism 100. The braking mechanism 500 includes a brake disc 510 and a brake caliper 520. The brake caliper 520 is configured to operably abut against the brake disc 510 (as shown in FIG. 3A) to place the wheel 400 in a braking state.

The wheel 400, the suspension mechanism 100, the braking mechanism 500, and the steering mechanism are integrated together to realize core functions such as driving, supporting, braking, and steering. Moreover, both the braking mechanism 500 and the steering mechanism are integrated between the suspension mechanism 100 and the wheel 400, thereby reducing the occupation of extra space, making the layout of the corner module more compact, and correspondingly reducing the overall mass of the corner module, realizing the lightweighting of the corner module while optimizing the layout space of the corner module.

In an embodiment of the present application, referring to FIG. 3A to FIG. 8, the braking mechanism 500 further includes a braking motor 530. The braking motor 530 is connected to the brake caliper 520 (shown in FIG. 7). The braking motor 530 is configured to drive the brake caliper 520 to move along the axial direction of the brake disc 510. For example, when braking is required, the driver depresses the brake pedal, thus transmitting a signal to the braking motor 530. The braking motor 530 drives the brake caliper 520 to move in a direction approaching the brake disc 510, thus causing the brake caliper 520 to abut against the brake disc 510. The rotation speed of the brake disc 510 is reduced under the friction between the brake caliper 520 and the brake disc 510, thus causing the brake disc 510 to stop rotating quickly, which in turn causes the wheel to stop rotating. After the brake pedal is released, the brake caliper 520 resets under the action of an elastic member and is released from the brake disc 510, thereby releasing the brake. In other embodiments, in addition to driving the brake caliper 520 to move via the braking motor 530, an electromagnetic brake may also be adopted. Specifically, reference may be made to the prior art, and details are not described herein again.

In an embodiment of the present application, the braking motor 530 includes a mover and a stator. The mover generates an alternating magnetic field, and the stator is subjected to the magnetic field to generate thrust, thereby pushing the mover to move linearly, which in turn drives the brake caliper 520 connected to the mover to move.

Further, referring to FIG. 3A to FIG. 8, the wheel 400 includes a wheel motor. One side of the wheel motor along the axial direction is connected with a driving shell. The upper end of the driving shell is rotatably connected to the upper swing arm 121, and the lower end of the driving shell is rotatably connected to the lower swing arm 122. In some embodiments, the driving shell and the swing arm assembly 120 may be rotatably connected through ball hinge points. For example, ball heads are arranged at the upper end and the lower end of the driving shell, respectively. The upper end of the driving shell is hinged to the upper swing arm 121 through the corresponding ball head, and the lower end of the driving shell is hinged to the lower swing arm 122 through the other corresponding ball head. In this way, steering of the wheel can be realized. In one of the embodiments, the brake disc 510 is integrally connected with the wheel motor, thereby making the layout of the corner module more compact and reducing space occupation.

In an embodiment of the present application, the wheel motor includes a stator fixedly disposed on the driving shell and a rotor rotatably disposed on the driving shell. A magnetic field is generated by the stator, and the rotor rotates under the influence of the magnetic field of the stator, thereby outputting torque and driving the wheel connected to the rotor to rotate. In some embodiments, the rotor is disposed outside the stator. In some embodiments, the stator may be a winding coil, and the rotor may be a rotating magnet. When current passes through the winding coil, a rotating magnetic field is generated, and the rotating magnet rotates following the direction of the magnetic field under the action of the rotating magnetic field.

In some embodiments, a plurality of winding coils are provided.

In some embodiments, the rotating magnet may be a permanent magnet.

In an embodiment of the present application, the surface of the winding coil along the axial direction is connected with silicon steel sheets. The silicon steel sheets are made of very thin steel plates, and the surfaces thereof are coated with an insulating layer. This design makes silicon steel sheets insulated from each other, effectively shortening the path of eddy currents formed by the current and reducing eddy current loss. Moreover, the silicon steel contains a certain proportion of silicon element, which changes the crystal structure of the material, thereby making the silicon steel easier to be magnetized and demagnetized, and reducing the hysteresis phenomenon. Therefore, the use of silicon steel sheets can significantly reduce hysteresis loss and improve the overall efficiency of the motor. The silicon steel has relatively high magnetic permeability, so it can more effectively guide and concentrate the magnetic field, thereby ensuring that more magnetic flux passes through the winding, and enhancing the electromagnetic performance of the motor. High magnetic permeability also helps reduce the required excitation current, thereby reducing copper loss (i.e., resistance loss in the winding coil). In addition, the silicon steel sheets may also play a role in supporting the winding coil and maintaining mechanical strength.

In an embodiment of the present application, the wheel 400 may further include a drive reduction mechanism. The outer rotor of the wheel motor is drivingly connected to the drive reduction mechanism, and is drivingly connected to the wheel through the drive reduction mechanism. For example, in some embodiments, the output torque and the rotational speed of the wheel motor, after being decelerated and torque-increased by a planetary gear reducer, are transmitted to the wheel. The vehicle can obtain a relatively high output torque, thereby obtaining a relatively large driving force.

In an embodiment of the present application, the wheel 400 may further include a drive controller. The drive controller is communicatively connected to the wheel motor. When the driver depresses the accelerator pedal, the vehicle control unit sends a signal to the drive controller to control the outer rotor of the wheel motor to drive the wheel to rotate together. When the driver depresses the brake pedal, the vehicle control unit sends a signal to the brake caliper 520, and the brake caliper 520 clamps the brake disc 510 to brake the wheel.

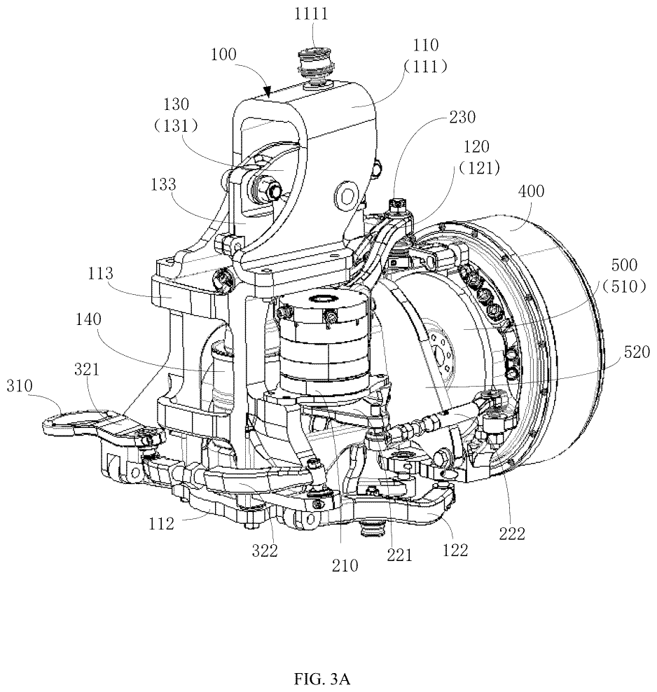

Further, as shown in FIG. 1 and FIG. 2, the vehicle frame 600 includes a first mounting frame 610, two second mounting frames 620, and two third mounting frames 630. The two second mounting frames 620 are disposed on two sides of the first mounting frame 610 along the length direction, respectively. Each third mounting frame 630 is provided on the side of the corresponding second mounting frame 620 facing away from the first mounting frame 610, and the height of the second mounting frame 620 is higher than the heights of the first mounting frame 610 and the third mounting frame 630. The first mounting frame 610, the second mounting frame 620, and the corresponding third mounting frame 630 enclose to form a space for accommodating the wheel 400 and the steering mechanism. The cooling system is disposed on the third mounting frame 630. By defining the positional relationship of the first mounting frame 610, the second mounting frame 620, and the corresponding third mounting frame 630, a space for accommodating the wheel 400, the steering mechanism, and the suspension mechanism 100 is enclosed, thereby facilitating the installation of the wheel 400, the steering mechanism, and the suspension mechanism 100.

Further, referring to FIG. 1 and FIG. 2, the electric drive vehicle modular chassis integrated with distributed corner modules provided by an embodiment of the present application further includes a battery mechanism 700. The battery mechanism 700 includes a battery pack and an elastic member. The vehicle frame 600 is provided with an installation cavity for accommodating the battery pack, and the battery pack abuts against the cavity wall of the installation cavity through the elastic member. By providing the installation cavity on the vehicle frame 600, it is convenient to accommodate the battery pack of the battery mechanism 700. By providing the elastic member between the battery pack and the cavity wall of the installation cavity, the battery pack abuts against the cavity wall of the installation cavity through the elastic member, thereby reducing damage to the battery pack caused by the mutual movement of the vehicle frame 600 and the battery pack.

In some other embodiments, the battery mechanism 700 further includes a battery rack. The battery pack is disposed in the installation cavity via the battery rack, and elastic members are provided between the battery pack and the battery rack, as well as between the battery rack and the installation cavity.

In some embodiments, the elastic member is a silicone pad or a sponge pad, etc.

Further, as shown in FIG. 1 and FIG. 2, the electric drive vehicle modular chassis integrated with distributed corner modules provided by an embodiment of the present application further includes a cooling mechanism 800 disposed on the vehicle frame 600. The cooling mechanism 800 is configured for cooling the battery mechanism 700. By providing the cooling mechanism 800 on the vehicle frame 600, the cooling mechanism 800 is utilized to dissipate heat from the battery pack of the battery mechanism 700. The cooling mechanism 800 is disposed on the third mounting frame 630, which optimizes the arrangement between multiple units of the electric drive vehicle modular chassis integrated with distributed corner modules.

In an embodiment of the present application, the cooling mechanism 800 includes a water tank, a liquid cooling pump, and an inlet of a heat exchanger connected sequentially through liquid cooling pipelines. The liquid cooling pipeline connected to the liquid cooling pump and the inlet of the heat exchanger passes through the battery pack; a water outlet of the heat exchanger is connected to the water tank, and an air outlet of the heat exchanger is communicated with the outside. The water tank is configured for containing coolant, and the liquid cooling pump is configured for pumping the coolant out of the water tank so that the coolant flows near the battery pack through the coolant pipeline and exchanges heat with the battery pack. The coolant in the coolant pipeline absorbs heat and becomes hot, and then flows through the coolant pipeline into the heat exchanger for cooling and heat dissipation. The heat exchanger discharges the heat to the air outside, thereby ensuring stable operation of the vehicle under high load and high speed. After being cooled by the heat exchanger, the coolant flows out of the heat exchanger and continues to flow back into the water tank, awaiting extraction by the liquid cooling pump.

Further, the electric drive vehicle modular chassis integrated with distributed corner modules provided by an embodiment of the present application further includes an electrical mechanism. The design of the electrical mechanism ensures the collaborative operation of various systems of the vehicle. The electrical mechanism includes: a vehicle control unit (VCU), wheel motor controllers, steering motor controllers, and an electro-mechanical braking (EMB) controller.

The VCU coordinates with controllers of all corner modules including wheel motor controllers, steering motor controllers, and EMB controllers, receives data from sensors such as vehicle speed, steering angle, and suspension height, calculates the optimal control strategy, and sends control instructions to each corner module through the CAN bus, thereby ensuring efficient collaboration of various functional modules.

Each corner module is equipped with two wheel motor controllers, responsible for regulating the output power of each electric drive system to ensure power balance and response.

Each corner module is equipped with two steering motor controllers, configured for the control of the main steering motor and the auxiliary steering motor, respectively. Since the corner module adopts a two-stage steering design, the steering motor controller provides a precise steering response by adjusting the steering angle in real time.

The EMB controller operates in synergy with the braking system, regulating the operating states of the electromagnetic braking and hydraulic braking systems to provide effective braking control.

In summary, connection between the corner modules of the present application and the vehicle frame 600: the corner modules are spherically hinged to the vehicle frame 600 (i.e., the suspension mechanism 100 is spherically hinged to the vehicle frame 600), thus providing movement capabilities in multiple degrees of freedom to adapt to the dynamic requirements of the vehicle's steering, suspension, and power systems.

Rotational degree of freedom: each corner module realizes a rotational connection with the vehicle frame 600 through the ball joint of the spherical hinge, thus allowing the corner module to adjust flexibly during steering and vehicle body movement. The design of the ball joint allows the corner module to maintain flexibility when the vehicle frame 600 deforms, turns, or the suspension adjusts, thus ensuring the correct angle of the wheel and the stability of contact with the ground.

Vertical and lateral movement: the connection method between each corner module and the vehicle frame 600 allows each corner module to move vertically (adapting to changes in suspension height) and laterally (adapting to roll of the vehicle body and steering) when the suspension mechanism 100 operates. This degree of freedom allows the corner module to respond to forces and movements in different directions when the vehicle is cornering, accelerating, or braking, thereby maintaining the stability of the vehicle.

Load distribution and vehicle body synergy: the connection between each corner module and the vehicle frame 600 allows the vehicle body and the corner module to jointly share the load and steering force from the road. When the vehicle accelerates, brakes, or turns, the load of the vehicle body is transmitted to each corner module through the corresponding ball joint, thereby ensuring that the drive, steering, and suspension system of each corner module can be independently adjusted, and providing the required support.

The battery mechanism 700 and the vehicle frame 600 of the present application: the installation cavity is located in the central area of the first mounting frame 610, that is, the battery mechanism 700 is arranged in the central area of the first mounting frame 610 to optimize the center of gravity of the vehicle.

Vertical and horizontal movement: the battery pack is arranged inside the installation cavity and usually does not participate in vertical or lateral movements. The battery installation position and structural design ensure that the battery is fixed on the vehicle frame 600, and that the movement of the vehicle frame 600 will not affect the stability of the battery when the suspension mechanism 100 operates. The installation cavity provides a solid-state support, thus ensuring the safety of the battery during the movement of the vehicle frame 600.

Load stability: the design of the battery pack being fixed to the vehicle frame 600 ensures the stability of the battery and good weight distribution of the vehicle body, so that the vehicle will not affect the center of gravity or handling performance due to changes in battery position under dynamic operating conditions.

Heat conduction and management: the cooling system of the battery is usually shared with the cooling system of the vehicle frame 600. Through connection methods such as pipes and heat exchangers, the temperature control of the battery cooperates with the cooling system of the vehicle frame 600. When the cooling system of the vehicle starts, the battery works synergistically with the cooling system of the vehicle frame 600 through cooling pipes to jointly ensure that the temperature of the battery during operation is maintained within a safe range.

Cooling mechanism 800 and vehicle frame 600 of the present application: The cooling system is responsible for controlling the temperatures of various components in the vehicle power system (such as the battery, electric motor, and steering system), and usually operates via liquid cooling. The relationship between the cooling mechanism 800 and the vehicle frame 600 is as follows.

Connection of coolant pipes with the vehicle frame 600: the pipes and heat dissipation devices of the cooling mechanism 800 are connected to the vehicle frame 600 through pipes, joints, and fixing brackets. Coolant flows through these pipes connected to key components requiring heat dissipation, such as the battery and the drive motor. The pipes of the cooling mechanism 800 are tightly connected to the vehicle frame 600, thus ensuring that the coolant can effectively transmit heat and the cooling effect is maintained.

Heat management cooperation with the vehicle frame 600: the heat exchanger of the cooling mechanism 800 operates synergistically with the radiator part of the vehicle frame 600. The coolant circulates in the system, taking heat away from components such as the battery, the electric motor, and the steering mechanism. The heat exchange between the radiator part of the cooling mechanism 800 of the vehicle frame 600 and the air outside ensures that the vehicle will not overheat when operating under high load, thereby maintaining the stable operation of various components.

Cooperation of the pump with the vehicle frame 600: the liquid cooling pump in the cooling system is responsible for driving the flow of coolant. Through the connection with the vehicle frame 600, the pump ensures that the coolant can effectively circulate through components such as the battery, the drive motor, and the steering mechanism. The vehicle frame 600 provides stable structural support for the cooling mechanism 800, thus ensuring precise arrangement and effective connection of the pump and pipes, and achieving high-efficiency work of temperature control.

The technical features of the above embodiments can be combined arbitrarily. For the sake of brevity of description, not all possible combinations of the technical features in the above embodiments are described. However, as long as there is no contradiction in the combinations of these technical features, these combinations should be considered as the scope recorded in this specification.

The above embodiments only express several implementation modes of the present application, and the descriptions thereof are relatively specific and detailed, but cannot be understood as a limitation on the scope of the patent application. It should be pointed out that for those of ordinary skill in the art, various deformations and improvements can be made without departing from the concept of the present application, and all these deformations and improvements belong to the protection scope of the present application. Therefore, the protection scope of the present application patent shall be subject to the appended claims.

What is claimed is:

1. An electric drive vehicle modular chassis integrated with distributed corner modules, comprising:
a vehicle frame;
a suspension mechanism;
a wheel connected to the vehicle frame via the suspension mechanism; and
a steering mechanism comprising a first steering assembly and a second steering assembly;
wherein the first steering assembly is disposed on the suspension mechanism, and the second steering assembly is disposed on the vehicle frame; the first steering assembly is configured to drive the wheel to rotate within a first angle range, and the second steering assembly is configured to drive the suspension mechanism to rotate within a second angle range, so that the suspension mechanism drives the wheel to rotate within the second angle range.

2. The electric drive vehicle modular chassis integrated with distributed corner modules according to claim 1, further comprising a battery mechanism, wherein the battery mechanism comprises a battery pack and an elastic member; the vehicle frame is provided with an installation cavity for accommodating the battery pack; and the battery pack abuts against a cavity wall of the installation cavity via the elastic member.

3. The electric drive vehicle modular chassis integrated with distributed corner modules according to claim 2, further comprising a cooling mechanism disposed on the vehicle frame and configured to cool the battery mechanism.

4. The electric drive vehicle modular chassis integrated with distributed corner modules according to claim 3, wherein the cooling mechanism comprises a water tank, a liquid cooling pump, and an inlet of a heat exchanger connected sequentially through liquid cooling pipelines; the liquid cooling pipeline connected to the liquid cooling pump and the inlet of the heat exchanger passes through the battery pack; a water outlet of the heat exchanger is connected to the water tank, and an air outlet of the heat exchanger is communicated with the outside.

5. The electric drive vehicle modular chassis integrated with distributed corner modules according to claim 1, wherein the vehicle frame comprises a first mounting frame, two second mounting frames, and two third mounting frames; the two second mounting frames are disposed on two sides of the first mounting frame along a length direction, respectively; each third mounting frame is disposed on a side of a corresponding second mounting frame facing away from the first mounting frame; and a height of the second mounting frame is higher than heights of the first mounting frame and the third mounting frame; the first mounting frame, the second mounting frame, and the third mounting frame enclose to form a space for accommodating the wheel and the steering mechanism.

6. The electric drive vehicle modular chassis integrated with distributed corner modules according to claim 1, wherein the first steering assembly comprises a first driving member, and a first transmission unit connected to an output end of the first driving member; the first driving member is fixed on the suspension mechanism, the first transmission unit is connected to the wheel, and the first driving member is capable of driving the first transmission unit to rotate, so that the first transmission unit drives the wheel to rotate within the first angle range; the second steering assembly comprises a second driving member, and a second transmission unit connected to an output end of the second driving member; the second driving member is fixed on the vehicle frame, the second transmission unit is connected to the suspension mechanism, and the second driving member is capable of driving the second transmission unit to rotate, so that the second transmission unit drives the suspension mechanism to rotate within the second angle range.

7. The electric drive vehicle modular chassis integrated with distributed corner modules according to claim 6, wherein the first transmission unit comprises a first swing arm and a first connecting rod connected to each other; an end of the first swing arm away from the first connecting rod is connected to the first driving member, and an end of the first connecting rod away from the first swing arm is spherically hinged to the wheel.

8. The electric drive vehicle modular chassis integrated with distributed corner modules according to claim 6, wherein the second transmission unit comprises a second swing arm and a second connecting rod connected to each other; an end of the second swing arm away from the second connecting rod is connected to the second driving member, and an end of the second connecting rod away from the second swing arm is spherically hinged to the suspension mechanism.

9. The electric drive vehicle modular chassis integrated with distributed corner modules according to claim 1, wherein the suspension mechanism comprises:
a mounting assembly connected to the vehicle frame;
a swing arm assembly, one end of the swing arm assembly being connected to the mounting assembly, and another end of the swing arm assembly being connected to the wheel; and
a damping assembly, connected to the mounting assembly and the swing arm assembly.

10. The electric drive vehicle modular chassis integrated with distributed corner modules according to claim 1, further comprising a braking mechanism, wherein the braking mechanism is configured to place the wheel in a braking state.

11. The electric drive vehicle modular chassis integrated with distributed corner modules according to claim 6, wherein
the suspension mechanism is spherically hinged to the wheel;
the suspension mechanism has a virtual kingpin axis (P) rotatably connected to the wheel; and
the first transmission unit is configured to drive the wheel to rotate around the virtual kingpin axis (P).

12. The electric drive vehicle modular chassis integrated with distributed corner modules according to claim 11, wherein
the suspension mechanism has an upper swing arm and a lower swing arm;
the lower swing arm comprises a first lower arm section and a second lower arm section;
the upper swing arm is spherically hinged to an upper part of the wheel; and
the first lower arm section and the second lower arm section are respectively spherically hinged to the bottom of the wheel;
extensions of the first lower arm section and the second lower arm section form an intersection point; and
the virtual kingpin axis (P) passes through the intersection point and a spherical hinge point where the upper swing arm is connected to the upper part of the wheel.

13. The electric drive vehicle modular chassis integrated with distributed corner modules according to claim 6, wherein
the suspension mechanism has a first connection component and a second connection component;
the first connection component and the second connection component are spherically hinged to the vehicle frame, respectively;
a line connecting the first connection component and the second connection component constructs a virtual secondary pin axis (Q); and
the second transmission unit is configured to drive the suspension mechanism to rotate around the virtual secondary pin axis (Q).

14. The electric drive vehicle modular chassis integrated with distributed corner modules according to claim 13, wherein
the first connection component is located at one end of the suspension mechanism along the vertical direction, and the second connection component is located at another end of the suspension mechanism along the vertical direction; and
the first transmission unit is located between the first connection component and the second connection component along the vertical direction.

15. The electric drive vehicle modular chassis integrated with distributed corner modules according to claim 7, wherein
a length of the first connecting rod is adjustable; and
the first driving member is a motor, disposed on the suspension mechanism and configured to drive the first swing arm to swing in a horizontal plane to drive the first connecting rod to swing.

16. The electric drive vehicle modular chassis integrated with distributed corner modules according to claim 8, wherein
a length of the second connecting rod is adjustable; and
the second driving member is a motor, fixed on the vehicle frame and configured to drive the second swing arm to swing in a horizontal plane to drive the second connecting rod to swing relative to the suspension mechanism, so that the suspension mechanism is capable of rotating around the virtual secondary pin axis (Q).

17. The electric drive vehicle modular chassis integrated with distributed corner modules according to claim 6, wherein the second transmission unit is disposed on a side of the suspension mechanism away from the wheel.

18. The electric drive vehicle modular chassis integrated with distributed corner modules according to claim 6, wherein the first angle range and the second angle range are −45° to +45°.

19. The electric drive vehicle modular chassis integrated with distributed corner modules according to claim 8, wherein
the second transmission unit has a locked state; and
when the second transmission unit is in the locked state, a rotation center of the second driving member, a connection point of the second swing arm and the second connecting rod, and a connection point of the second connecting rod and the suspension mechanism are located on a same straight line (L).

20. The electric drive vehicle modular chassis integrated with distributed corner modules according to claim 16, wherein the vehicle frame is provided with four sets of corner modules, and each set of corner module comprises one wheel, one braking mechanism, one suspension mechanism, and one steering mechanism.
